(19) United States
(12) Patent Application Publication
(10) Pub. No.: US 2018/0185853 A1
(43) Pub. Date: Jul. 5, 2018

(54) INTELLIGENT ELUTRIATION MAGNETIC SEPARATOR AND MAGNETIC-SEPARATING METHOD

(71) Applicant: LONGI MAGNET Co., Ltd., Fushun City, Liaoning (CN)

(72) Inventors: Chengchen ZHANG, Fushun City, Liaoning (CN); Deliang ZHENG, Fushun City, Liaoning (CN); Chao WANG, Fushun City, Liaoning (CN); Dongfang ZHU, Fushun City, Liaoning (CN)

(73) Assignee: Longi Magnet Co., Ltd., Fushun City, Liaoning (CN)

(21) Appl. No.: 15/526,999

(22) PCT Filed: Jun. 21, 2016
(86) PCT No.: PCT/CN16/86512

§ 371 Date: May 15, 2017

(30) Foreign Application Priority Data
Jun. 15, 2016 (CN) 201610415984.9

(51) Int. Cl. B03B 5/40; B03C 1/32; B03C 1/30; B03B 5/68; B03C 1/033

(52) U.S. Cl. CPC B03B 5/40; B03C 1/32; B03C 1/0335; B03B 5/68; B03C 1/30

(57) ABSTRACT

An intelligent elutriation magnetic separator includes a material feeding trough, an overflow trough, a separation tank, excitation coils, a balance column, an outer cover, a water supply system, a lower cone, a concentrate discharging system and sensors. The excitation coils are sleeved outside the periphery of the separation tank, and the outer cover is sleeved outside the excitation coils. The balance column is mounted on the inner sides of the separation tank; the balance column and the separation tank are coaxially mounted; and the water supply system is located on the separation tank. The lower cone and the separation tank are mounted intercommunicated at the bottom. The concentrate discharging system is mounted on the bottom of the lower cone; and the sensor is mounted on the lower cone for measuring the slurry concentration in the separation tank. An automatic intelligent program is used to control the intelligent elutriation magnetic separator.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This invention belongs to the technical field of beneficiation and specifically relates to an intelligent elutriation magnetic separator and a magnetic-separating method, which are adaptable for separating minerals through combining water/magnetic field and gravitational force.

### 2. Description of Related Art Including Information Disclosed Under 37 CFR 1.97 and 37 CFR 1.98

A magnetic separator is a common magnetic metallic mineral beneficiation device, is usually used in wet-type fine magnetic-separating practices and it is used for improving the grade of ores or thickening the selected granularity, on the premise of a certain grade. The elutriation magnetic separator is usually composed of a separation tank, excitation coils, an outer cover, a material feeding trough, an overflow trough, a lower cone, a water supply system, a concentrate discharging system, and a controlling cabinet, etc. The operational principle is that magnetic particles move downward to the concentrate discharging system on the bottom to form a concentrate under the action of the magnetic field force and gravitational force after ore slurry is fed into the separation tank via an ore feeding trough and non-magnetic impurity particles float upward to the overflow trough with ascending water overflows and to be discharged astailing

At present, the fine dressing equipments used in magnetic iron ore beneficiation factories comprise magnetic separators, slurry removal grooves, magnetic separation tanks, etc. The magnetic separators are products of a permanent magnetic type, the operational principle thereof is to absorb magnetic materials out under the action of magnetic force, and the concentrates separated are mostly with magnetic inclusion, which affects the grade of the concentrate. The desliming tank are mostly also products of a permanent magnetic type and are less used nowadays, and the operational principle is to perform the separation by utilizing the gravitational force of the materials, the ascending water buoyancy, the complex effect of the magnetic force; however, the fluctuation of selected materials influences greatly the separation effects because the magnetic field thereof is a single and fixed magnetic field and the separation efficiency is low. The magnetic separation cylinders are products of a electro-magnetic type and the ability of improving the grade is satisfied; however, the stability of the separation indexes is poor, the product structure thereof is that a plurality of groups of coils are sleeved from top to bottom outside the periphery of the separation cylinder, a water supply system and a concentrate discharging system are provided on the lower portion of the separation tank, and an ore feeding trough and an overflow trough are arranged on the upper portion of the separation tank. The operational principle thereof is that the coils are electrified successively and alternatively to form a intermittently pulsed magnetic field, the alternating states of aggregation, dispersion and aggregation are produced by magnetic particles with the existence of the magnetic field and meanwhile, non-magnetic gangue, mud slurry and magnetic particles are separated under the action of the gravitational force and ascending water buoyancy; however, because the states of the materials in the separation process thereof are aggregation, dispersion and aggregation, the separation continuity of the states is poor, the separation efficiency is low, the fluctuation of selected materials influences greatly the selection index, and the relative processing ability is low.

### BRIEF SUMMARY OF THE INVENTION

In order to solve the above technical problem, the invention provides an intelligent magnetic elutriating method, which are specifically an intelligent elutriation magnetic separator and a magnetic-separating method with functions of pressure supplement and water supply. The existing refining devices are optimized and improved, thus the separation efficiency is improved, separation indexes are stabilized, the improving amplitude of the grade is increased, the fluctuation of materials supply is counteracted, water is saved and the environment is protected.

According to a first technical solution of the invention, an intelligent elutriation magnetic separator is provided, which comprises a material feeding trough 1, an overflow trough 2, a separation tank 3, excitation coils 4, a balance column 5, an outer cover 6, a water supply system 7, a lower cone 8, a concentrate discharging system 10 sensors 11. The material feeding trough 1, the overflow trough 2 and the separation tank 3 are arranged respectively thereon from top to bottom, a plurality of groups of excitation coils 4 are sleeved outside the periphery of the separation tank 3, the outer cover 6 is sleeved outside the excitation coils 4, the balance column 5 is mounted on the middle lower portions of the inner sides of the separation tank 3, the balance column 5 and the separation tank 3 are coaxially mounted, and the water supply system 7 is located on the middle lower portions of the separation tank 3; the lower cone 8 and the separation tank 3 are mounted intercommunicated at the bottom; the concentrate discharging system 10 is mounted at the bottom of the lower cone 8; and the sensor 11 is mounted on the lower cone 8 for measuring the slurry concentration in the separation tank 3.

Preferably, the separator is an intelligent magnetic elutriation with an auxiliary water supplement system, and the auxiliary water supplement system 9, which is mounted on the lower cone 8.

Among other things, the material feeding trough 1 is mounted on the overflow trough 2 through brackets 24, the number of which can be three or more. The material feeding trough 1, the overflow trough 2 and the separation tank 3 are coaxial structures. A material feeding pipe 21 is connected on the lower portion of the material feeding trough 1 and is coaxial with the separation tank 3. The overflow trough 2 and the separation tank 3 are connected through a flange 29. The overflow trough 2 is composed of peripheral enclosing plate 25, an inclined bottom plate 26, an inner enclosing plate 27, a lower cone-plate 28, a flange for overflow trough 29 and a tailing ore pipe 20; the peripheral enclosing plate 25 and the inner enclosing plate 27 are connected by the inclined bottom plate 26 to constitute a tailing ore chute, and the inclined bottom plate 26 is an inclined structure that is high at one end and low at the other end.

Furthermore, the inner enclosing plate 27 and the flange for overflow trough 29 are connected through the lower cone-plate 28, which plays a role of transition, and the diameter of the inner enclosing plate 27 is larger than that of the separation tank 3.

More preferably, the spacing between the excitation coils 4 and the outer cover 6 is 1-500 mm. The lower portion of the separation tank 3 is connected with the water supply system of a circular shape 7, the internal chamber of which is connected with the main water supply pipe 23 in the tangential direction and there are one or more main water supply pipes. The auxiliary water supplement system 9 comprises an auxiliary water supply pipe 13, a flow guide pipe 16 and tangential spiral divisional pipes 17 and there are one or more auxiliary water supply pipes 13.

More preferably, the direction of the water outlet of the tangential spiral divisional pipes 17 is peripheral tangential direction, and the tangential spiral divisional pipes 17 can be two or more.

Preferably, the sensor 9 is a concentration sensor or a pressure sensor for measuring the slurry density in the separation tank 3. The concentrate discharging system 10 comprises a pipe clamp valve and an electric controller 12.

According to a second technical solution of the invention, a magnetic-separating method using the intelligent elutriation magnetic separator of the above claims is provided, which comprises the following steps:

Step 1, the slurry is fed through the material feeding trough 1, flows downward along the material feeding pipe 21 and enters uniformly to the separation tank 3 from a cage-type exit on the lower portion of the material feeding pipe 21;

Step 2, after the slurry is fed into the separation tank 3, a magnetic chain in a vertical direction is formed by the magnetic particles that are connected by the action of downward movement magnetic force and gravitational force generated by the a plurality of groups of excitation coils 4 and suspends downwards; the materials are blocked by the balance column 5 and are dispersed at the space between the balance column 5 and the separation tank 3; and the magnetic field intensity and the pulse cycle of all the coils in the excitation coils 4 are adjustable;

Step 3, the non-magnetic gangue particles are distributed in the periphery of the magnetic chain, the risen rinse water is fed into the separation tank 3 in the tangential direction from the water supply system 7 on the lower portion of the separation tank 3 and moves upwards in a spiral mode inside the separation tank 3, and the gangue particles float with the ascending water to the overflow trough 2 overflows and to be discharged to form a tailing ore;

Step 4, the pressure supplement water is fed from the system of pressure supplement and water supply 9 located in the lower cone 8 and is flushed into the separation tank 3 from the tangential spiral divisional pipes 17 through the flow guide pipe 16;

Step 5, the magnetic particles move downwards to the concentrate discharging system 10 in a magnetic chain state and to be discharged.

An automatic intelligent program is used to control the intelligent elutriation magnetic separator and the magnetic-separating method of the invention, the effect of fluctuation of feeding quantity can be counteracted, high-grade concentrates can be obtained, and overflow and large amount of iron lost into the tailing are effectively avoided. Efficiency and large scale of the devices are implemented by the invention through using the technology “magnetic chain suspend downwards”. The operational stability is good, the intelligent degree is high and the operation is simple. The main principle thereof is to drag and flush the materials through the separation action of a complex force field of the magnetic force, gravitational force and water buoyancy to make the iron powder sink, the tailing ore rise and to achieve the purpose of improving the grade and decreasing impurity.

### BRIEF DESCRIPTION OF THE SEVERAL VIEWS OF THE DRAWINGS

FIG. 1 is a structural schematic view of the intelligent elutriation magnetic separator according to the invention.

FIG. 2 is a left-sided elevation view of the intelligent elutriation magnetic separator in FIG. 1.

FIG. 3 is a structural schematic view of the material feeding trough in the intelligent elutriation magnetic separator.

FIG. 4 is a top plan view of the material feeding trough in FIG. 3.

FIG. 5 is the second top plan view of the material feeding trough in FIG. 3.

FIG. 6 is a structural schematic view of the cage-type exit in the intelligent elutriation magnetic separator.

FIG. 7 is a schematic view of the second structure of cage-type exit in the intelligent elutriation magnetic separator.

FIG. 8 is a schematic view of the third structure of cage-type exit in the intelligent elutriation magnetic separator.

FIG. 9 is a structural schematic view of the overflow trough in the intelligent elutriation magnetic separator.

FIG. 10 is a structural schematic view of the auxiliary water supplement system in the intelligent elutriation magnetic separator.

FIG. 11 is a top view of the auxiliary water supplement system shown in FIG. 10.

### DETAILED DESCRIPTION OF THE INVENTION

The technical solution in embodiments of the present invention is clearly and completely described below with reference to drawings in the embodiments of the present invention. Obviously, the described embodiments are only a portion of embodiments in the present invention but not all the embodiments of the present invention. Based on the embodiments in the present invention, an ordinary person skilled in the art can obtain all other embodiments without involving any inventive effort, which all shall fall within the protective scope of the present invention. Besides, the protective scope of the present invention should not be regarded as limit in the following specific structures or specific parameters.

The intelligent elutriation magnetic separator of the invention mainly comprises a material feeding trough 1, an overflow trough 2, a separation tank 3, excitation coils 4, a balance column 5, an outer cover 6, a water supply system 7, a lower cone 8, a concentrate discharging system 10 and a sensor 11. The slurry is fed through the material feeding trough 1, flows downward along the material feeding pipe 21 and enters uniformly to the separation tank 3 from a cage-type exit on the lower portion of the material feeding pipe 21. A magnetic chain in a vertical direction is formed by the magnetic particles that are connected by the action of downward movement magnetic force and gravitational force generated by a plurality of groups of excitation coils 4 and suspends downwards. The downward movement process of the magnetic chain is in a continuous mode to ensure the high efficient operation of the device. The non-magnetic gangue particles are distributed in the periphery of the magnetic chain, and the lean intergrowth with weak magnetism and a small amount of gangue are carried in the magnetic chain. The risen rinse water is fed into the separation tank 3 in the tangential direction from the water supply system 7 on the lower portion of the separation tank 3 and moves upwards in a spiral mode inside the separation tank 3, and the gangue particles float with the ascending water to the overflow trough 2 overflows and to be discharged to form tailing. Meanwhile, the gangue and lean intergrowth carried in the magnetic chain are disengaged from the magnetic chain by the action of the transverse cutting force of the spiral ascending water and also overflows and are discharged along with the ascending water. In order to avoid the transverse cutting force of the spiral ascending water in the rising process from being weakened, the water is fed from the auxiliary water supplement system 9 located in the lower cone 8 and is flushed into the separation tank 3 from the tangential spiral divisional pipes 17 through the flow guide pipe 16, the rotation of the spiral ascending water is further assisted. Moreover, the magnetic particles move downward to the concentrate discharging system 10 in a magnetic chain state and concentrates are discharged. The concentrate discharging system 10 comprises a pipe clamp valve and an electric controller 12, and the flux of the valve is automatically adjusted according to the fluctuation of the materials fed. The separation state parameters of the materials in the separation tank 3 are collected by the sensor 11 located on the lower cone to provide the basic data for automatic adjustment and ensure the device to be able to counteract the fluctuation of the materials feeding and achieve intelligent control.

The operational principle of the invention of the intelligent elutriation magnetic separator and the process (the method of using the intelligent elutriation magnetic separator) are introduced in detail below step by step:

Step 1, the slurry is fed through the material feeding trough 1. There are a plurality of schemes about the feeding mode and the feeding point: the slurry can either be fed downward directly from the upper portion of the material feeding trough 1, or can be fed transversely from a material feeding pipe 22 that is connected outside the periphery of the material feeding trough 1. Moreover the material feeding pipe 23 and the material feeding trough 1 can either be vertically connected or can be connected in the tangential direction on the periphery. The slurry flows downward along the material feeding pipe 21 and enters uniformly to the separation tank 3 from a cage-type exit 18 on the lower portion of the material feeding pipe 21. The cage-type exit 18 is generally of a vertical strip-hole structure, of a circular-hole structure or of a transverse strip-hole structure.

Step 2, after the slurry is fed into the separation tank 3, a magnetic chain in a vertical direction is formed by the magnetic particles that are connected by the action of downward movement magnetic force and gravitational force generated by the a plurality of groups of excitation coils 4 and suspends downwards. Because the magnetic field in the central region of the separation tank 3 is too small, a balance column 5 is mounted the central region of the separation tank 3. The materials are blocked by the balance column 5 and are dispersed in the space between the balance column 5 and the separation tank 3. The balance column 5 can be in a cylindrical shape and a round platform shape, and meanwhile has the function to further assist the ascending water to rotate. The downward movement process of the magnetic chain is in a continuous mode to ensure the high operation of the device. The magnetic field intensity and the pulse cycle of all the coils in the excitation coils 4 are adjustable. There are multi-modes in excitation. An upper coil 19 located on the uppermost portion and coil 14 located on the lowermost portion are generally configured as normally-opened in excitation. The other coils of the excitation coils 4 are generally configured as pulse in excitation, the sequence of excitation is from top to bottom, and the alternating process of excitation is in a continuous mode without any spacing. There can be a plurality of excitation combination schemes, and each coil can be excited alone or every two or pluralities of adjacent coils can be combined as one group in excitation.

Step 3, the non-magnetic gangue particles are distributed in the periphery of the magnetic chain, and the lean intergrowth with weak magnetism and a small amount of gangue are carried in the magnetic chain. The risen rinse water is fed into the separation tank 3 in the tangential direction from the water supply system 7 on the lower portion of the separation tank 3 and moves upwards in a spiral mode inside the separation tank 3, and the gangue particles float with the ascending water to the overflow trough 2 overflows and to be discharged to form a tailing ore. Meanwhile, the gangue and lean intergrowth carried in the magnetic chain are disengaged from the magnetic chain by the action of the transverse cutting force of the spiral ascending water and also overflows and are discharged along with the ascending water.

Step 4, the pressurized water is fed from the Auxiliary water supplement system 9 located in the lower cone 8 and is flushed into the separation tank 3 from the tangential spiral divisional pipes 17 through the flow guide pipe 16. This mode is to avoid the transverse cutting force of the spiral ascending water in the rising process from being weakened, and the rotation of the spiral ascending water is further assisted.

Step 5, the magnetic particles move downwards to the concentrate discharging system 10 in a magnetic chain state to be discharged concentrates. The concentrate discharging system 10 comprises a pipe clamp valve and an electric controller 12, and the flux of the valve is automatically adjusted according to the fluctuation of the materials fed. The conditions of materials in the separation tank 3 are collected by the sensor 11 located on the lower cone to provide the basic data for automatic adjustment and ensure the device to be able to counteract the fluctuation of the materials and achieve intelligent control.

Specifically, the fundamental structure of the intelligent elutriation magnetic separator of the invention comprises a material feeding trough 1, an overflow trough 2, a separation tank 3, excitation coils 4, a balance column 5, an outer cover 6, a water supply system 7, a lower cone 8, a concentrate discharging system 10 and a sensor 11. The general structure is respectively from top to bottom the material feeding trough 1, the overflow trough 2 and the separation tank 3, a plurality of groups of excitation coils 4 are sleeved outside the periphery of the separation tank 3, the outer cover 6 is sleeved outside the excitation coils 4, the balance column 5 is mounted on the middle lower portions of the inner sides of the separation tank 3, the balance column 5 and the separation tank 3 are coaxially mounted, and the water supply system 7 is located on the middle lower portions of the separation tank 3; the lower cone 8 and the separation tank 3 are mounted intercommunicated at the bottom; the concentrate discharging system 10 is mounted on the bottom of the lower cone 8; and the sensor 11 is mounted on the lower cone 8 for measuring the slurry concentration in the separation tank 3.

Among other things, the material feeding trough 1 is mounted on the overflow trough 2 through the brackets 24, the number of which can be three or more. The feeding trough 1, the overflow trough 2 and the separation tank 3 are coaxial structures.

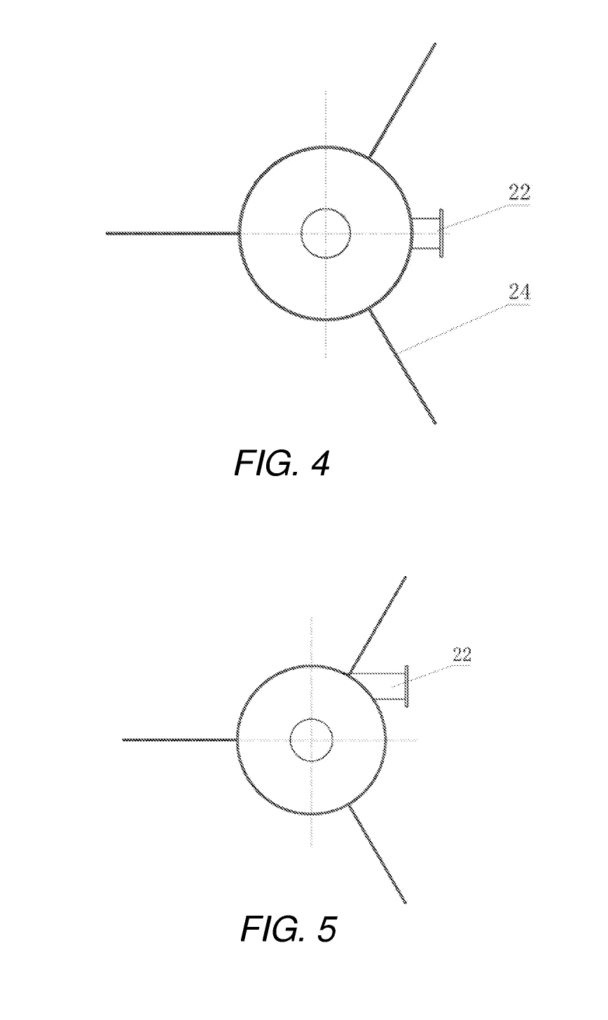

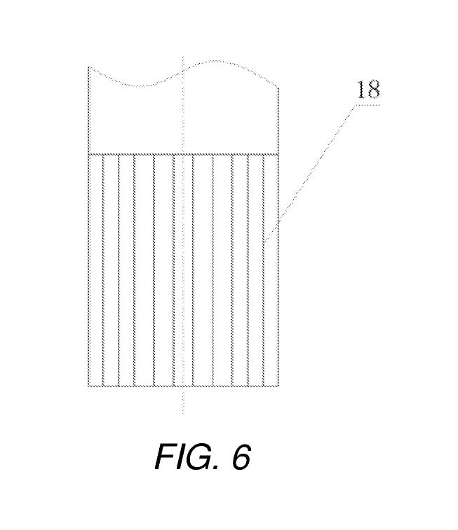

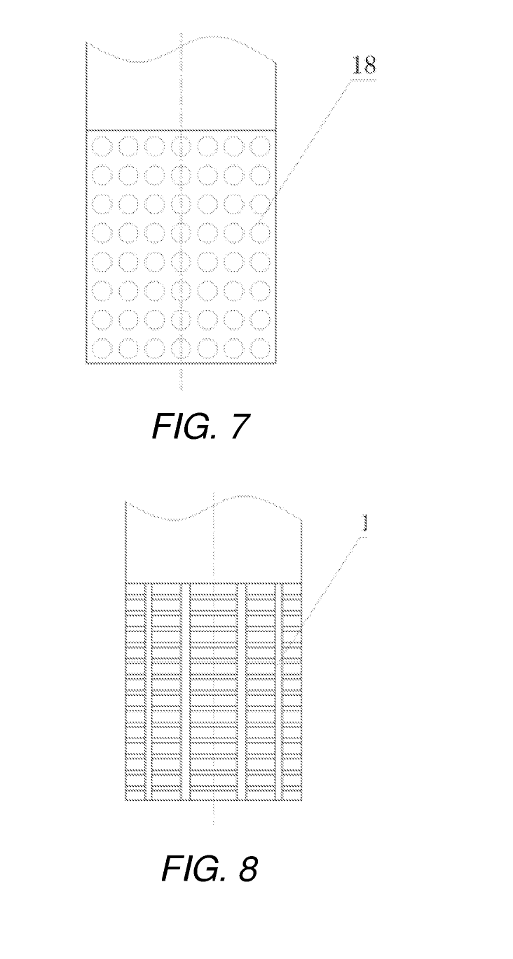

Preferably, the material feeding pipe 22 is connected with the outside of the periphery of the material feeding trough 1. It can be seen from FIGS. 4 and 5 that the material feeding pipe 22 and the material feeding trough 1 can be connected vertically or can be connected in the tangential direction on the periphery. The lower portion of the material feeding trough 1 is connected with the material feeding pipe 21, which is coaxial with the separation tank 3. The lower portion of the material feeding pipe 21 is with a cage-type exit 18. It can be seen from FIGS. 6-8 that the cage-type exit 18 is generally of a vertical strip-hole structure, of a circular-hole structure or of a transverse strip-hole structure, but is not limited to these structures. The overflow trough 2 and the separation tank 3 are connected through a flange 29. The overflow trough 2 is composed of peripheral enclosing plate 25, an inclined bottom plate 26, an inner enclosing plate 27, a lower cone-plate 28, a flange for overflow trough 29 and a tailing ore pipe 20; the peripheral enclosing plate 25 and the inner enclosing plate 27 are connected by the inclined bottom plate 26 to constitute a tailing ore chute, and the inclined bottom plate 26 is an inclined structure that is high at one end and low at the other end. The inner enclosing plate 2 and the flange for overflow trough 29 are connected through the lower cone-plate 28, which plays a role of transition, and the diameter of the inner enclosing plate 27 is larger than that of the separation tank 3.

The magnetic field intensity and the pulse cycle of all the coils in the excitation coils 4 are adjustable. There is a plurality of modes in excitation. An upper coil 19 located on the uppermost portion and a lower coil 14 located on the lowermost portion are generally configured as normally-opened in excitation. The other coils of the excitation coils 4 are generally configured as pulse in excitation, the sequence of excitation is from top to bottom, and the alternating process of excitation is in a continuous mode without any spacing. There can be a plurality of excitation combination schemes, and each coil can be excited alone or every two or pluralities of adjacent coils can be combined as one group in excitation. The outer cover 6 is sleeved outside the excitation coils 4, and the spacing between the excitation coils 4 and the outer cover 6 is 1-500 mm and is generally 5-200 mm. The lower portion of the separation tank 3 is connected with the ring-shaped water supply system 7, the internal chamber of which is connected with the main water supply pipe 23 in the tangential direction, and the main water supply pipe 23 can be designed as one or more. The inner wall of the ring-shaped water supply system 7 and the separation tank 3 are assembled as a whole and a plurality of water outlets are distributed uniformly on the periphery thereof.

The lower cone 8 is connected with the bottom of the separation tank 3. The auxiliary water supplement system 9 is connected with the lower cone 8 and comprises an auxiliary water supply pipe 13, a flow guide pipe 16 and tangential spiral divisional pipes 17, the auxiliary water supply pipe 13 is mounted on the lower cone 8, the lower portion of the flow guide pipe 16 is connected with the auxiliary water supply pipe 13, and the upper portion of the flow guide pipe 16 is connected with the tangential spiral divisional pipes 17, which is located on the middle portion of the separation tank. The number of the auxiliary water supply pipe 13 can be designed as one or more. The direction of the water outlet of the tangential spiral divisional pipes 17 is in the tangential direction on the periphery. The tangential spiral divisional pipes 17 can be two or more. The sensor 9 is mounted on the lower cone 8 and is in intercommunicated with the internal chamber of the lower cone 8, and the sensor 9 can be a concentration sensor or a pressure sensor. The bottom of the lower cone 8 is connected with the concentrate discharging system 10, which is a pipe clamp valve and an electric controller 12.

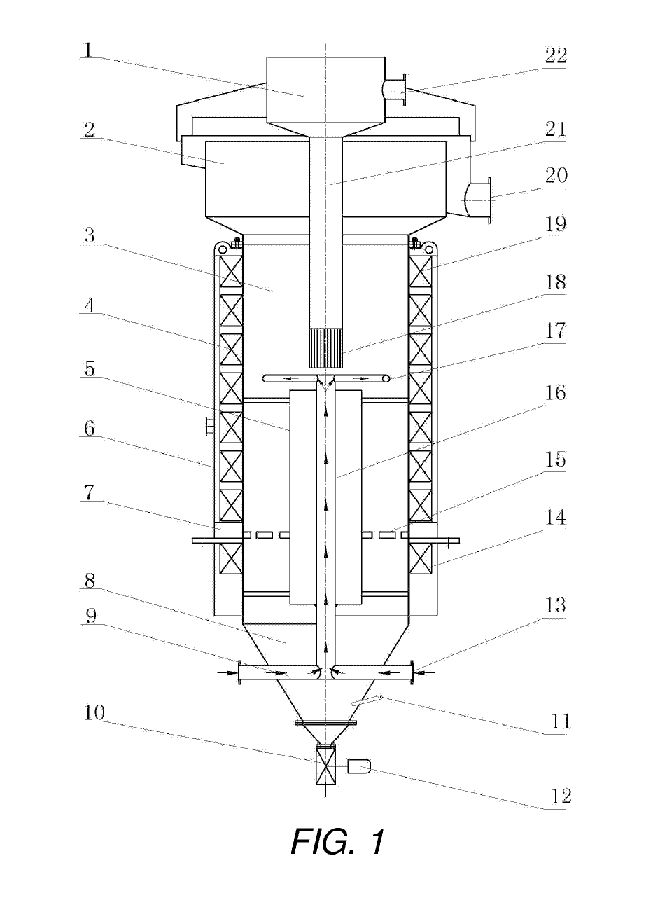

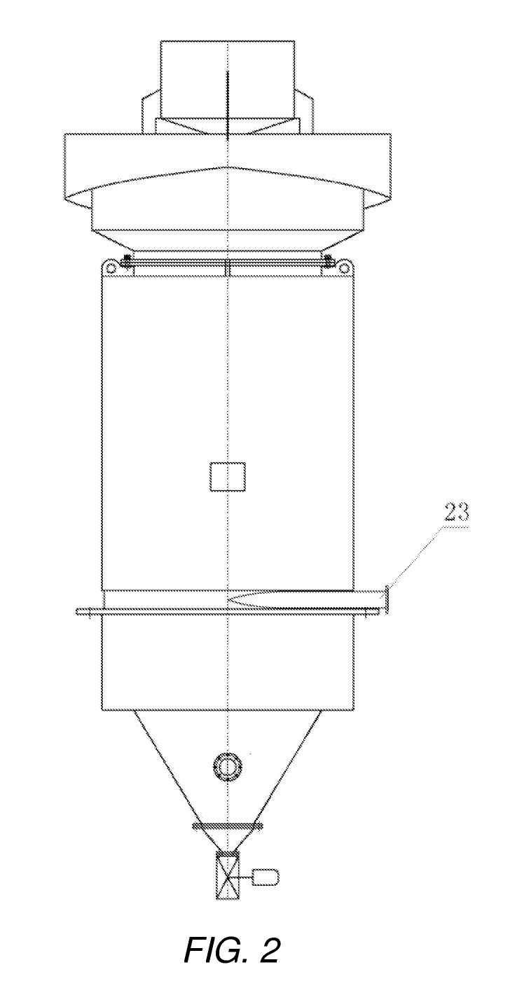

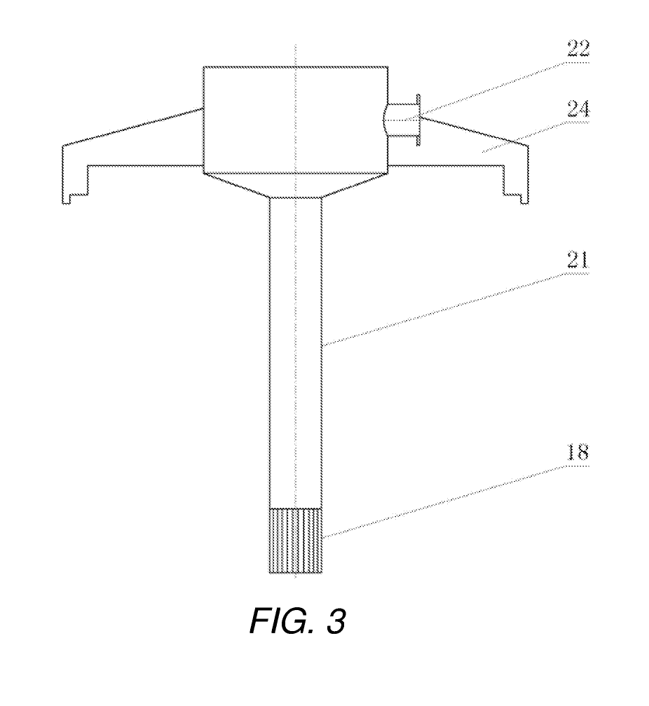

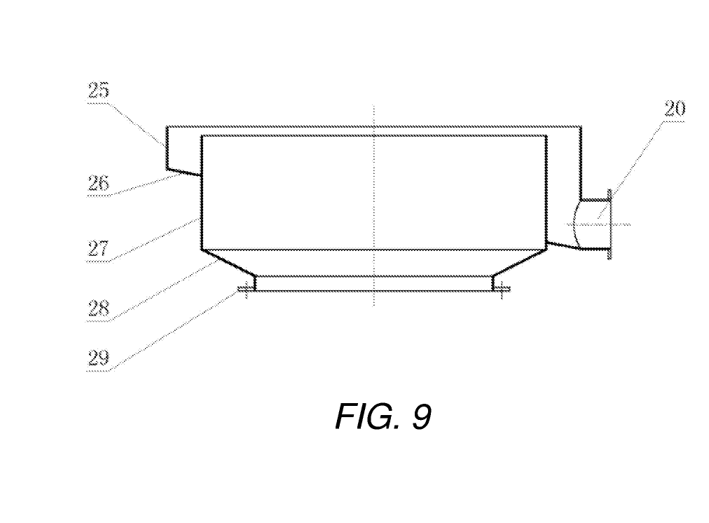

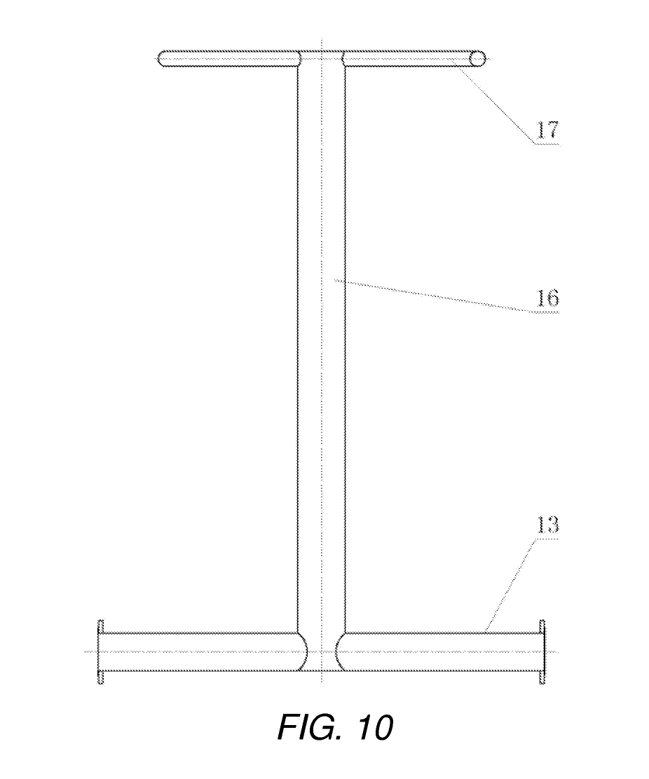

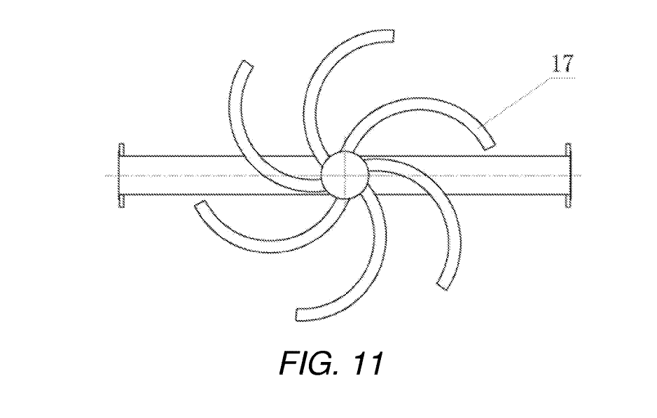

The intelligent elutriation magnetic separator of the invention will be further elaborated below, in accordance with the figures. As shown in FIGS. 1-11, the intelligent elutriation magnetic separator of the invention comprises a material feeding trough 1, an overflow trough 2, a separation tank 3, excitation coils 4, a balance column 5, an outer cover 6, a water supply system 7, a lower cone 8, a concentrate discharging system 10 and a sensor 11. The general structure is respectively from top to bottom the material feeding trough 1, the overflow trough 2 and the separation tank 3, a plurality of groups of excitation coils 4 are sleeved outside the periphery of the separation tank 3, the outer cover 6 is sleeved outside the excitation coils 4, the balance column 5 is mounted on the middle lower portions of the inner sides of the separation tank 3, the balance column 5 and the separation tank 3 are coaxially mounted, and the water supply system 7 is located on the middle lower portions of the separation tank 3; the lower cone 8 and the separation tank 3 are mounted intercommunicated at the bottom; the concentrate discharging system 10 is mounted on the bottom of the lower cone 8; and the sensor 11 is mounted on the lower cone 8 for measuring the slurry concentration in the separation tank 3. The structure of the device will be further elaborated below:

The material feeding trough 1 is located on the uppermost portion of the device and is mounted on the overflow trough 2 through the brackets 24, the number of which can be three or more. The material feeding trough 1, the overflow trough 2 and the separation tank 3 are coaxial structures. The material feeding pipe 22 is connected with the outside of the periphery of the material feeding trough 1. It can be seen from FIGS. 4 and 5 that the material feeding pipe 22 and the material feeding trough 1 can be connected vertically or can be connected in the tangential direction on the periphery. The lower portion of the material feeding trough 1 is connected with the material feeding pipe 21, which is coaxial with the separation tank 3. The lower portion of the material feeding pipe 21 is a cage-type exit 18. It can be seen from FIGS. 6-8 that the cage-type exit 18 is generally of a vertical strip-hole structure, of a circular-hole structure or of a transverse strip-hole structure, but is not limited to these structures.

The overflow trough 2 is located on the lower portion of the material feeding trough 1. The overflow trough 2 and the separation tank 3 are connected through a flange 29. The overflow trough 2 is composed of peripheral enclosing plate 25, an inclined bottom plate 26, an inner enclosing plate 27, a lower cone-plate 28, a flange for overflow trough 29 and a tailing ore pipe 20; the peripheral enclosing plate 25 and the inner enclosing plate 27 are connected by the inclined bottom plate 26 to constitute a tailing ore chute, and the inclined bottom plate 26 is an inclined structure that is high at one end and low at the other end. The inner enclosing plate 2 and the flange for overflow trough 29 are connected through the lower cone-plate 28, which plays a role of transition, and the diameter of the inner enclosing plate 27 is larger than that of the separation tank 3.

A plurality of groups of excitation coils 4 are sleeved outside the periphery of the separation tank 3. The magnetic field intensity and the pulse cycle of all the coils in the excitation coils 4 are adjustable. There is a plurality of modes in excitation. An upper coil 19 located on the uppermost portion and a lower coil 14 located on the lowermost portion are generally configured as normally-opened in excitation. The other coils of the excitation coils 4 are generally configured as pulse in excitation, the sequence of excitation is from top to bottom, and the alternating process of excitation is in a continuous mode without any spacing. There can be a plurality of excitation combination schemes, and each coil can excited alone or every two or pluralities of adjacent coils can be combined as one group in excitation. The outer cover 6 is sleeved outside the excitation coils 4, and the spacing between the excitation coils 4 and the outer cover 6 is 1-500 mm (millimeter) and is generally 5-200 mm (millimeter). The balance column 5 is mounted on the middle lower portion inside the separation tank 3 and the balance column 5 and the separation tank 3 are mounted coaxially.

The lower portion of the separation tank 3 is connected with the ring-shaped water supply system 7, the internal chamber of which is connected with the main water supply pipe 23 in the tangential direction, and the main water supply pipe 23 can be designed as one or more. The inner wall of the ring-shaped water supply system 7 and the separation tank 3 are assembled as a whole and a plurality of water outlets 17 are distributed uniformly on the periphery thereof.

The lower cone 8 is connected with the bottom of the separation tank 3. The auxiliary water supplement system 9 is connected with the lower cone 8 and comprises an auxiliary water supply pipe 13, a flow guide pipe 16 and tangential spiral divisional pipes 17. The number of the auxiliary water supply pipe 13 can be designed as one or more. The direction of the water outlet of the tangential spiral divisional pipes 17 is in the tangential direction on the periphery. The tangential spiral divisional pipes 17 can be two or more. The sensor 9 is mounted on the lower cone 8 and is mounted intercommunicated with the internal chamber of the lower cone 8, and the sensor 9 can be a concentration sensor or a pressure sensor. The bottom of the lower cone 8 is connected with the concentrate discharging system 10, which is a pipe clamp valve and an electric controller 12.

The above is only preferred specific embodiments of the invention; however, the scope of protection of the invention is not limited to this. Any modification or substitution that is easy to conceive by a person skilled in the art within the technical scope disclosed in the invention should be included in the scope of protection of the invention. It should be understood by an ordinary person in the art that any variety of modification could be made in format and detail without departing from the spirit and scope of the invention defined by the appended claims.

1. An intelligent elutriation magnetic separator, comprising:
a material feeding trough;
an overflow trough;
a separation tank;
excitation coils;
a balance column;
an outer cover;
a water supply system;
a lower cone;
a concentrate discharging system; and
a sensor,
wherein said material feeding trough, the overflow trough and the separation tank are mounted respectively from top to bottom and sleeved outside the periphery of the separation tank,
wherein the outer cover is sleeved outside the excitation coils,
wherein the balance column is mounted on the middle lower portions of the inner sides of the separation tank,
wherein the balance column and the separation tank are coaxially mounted,
wherein the water supply system is located on the middle lower portions of the separation tank,
wherein the lower cone and the separation tank are mounted intercommunicated at the bottom
wherein the concentrate discharging system is mounted on the bottom of the lower cone, and
wherein the sensor is mounted on the lower cone for measuring the slurry concentration in the separation tank.

2. The intelligent elutriation magnetic separator of claim 1, further comprising: an auxiliary water supplement system mounted on the lower cone.

3. The intelligent elutriation magnetic separator of claim 1, wherein the material feeding trough is mounted on the overflow trough through brackets, the number of which can be three or more.

4. The intelligent elutriation magnetic separator of claim 2, wherein the material feeding trough, the overflow trough and the separation tank are coaxial.

5. The intelligent elutriation magnetic separator of claim 2, wherein the material feeding trough has a periphery with a material feeding pipe connected to an outside of the periphery.

6. The intelligent elutriation magnetic separator of claim 2, wherein the material feeding trough has a lower portion with a material feeding pipe coaxial with the separation tank.

7. The intelligent elutriation magnetic separator of claim 1, wherein the overflow trough (2) and the separation tank are connected through a flange.

8. The intelligent elutriation magnetic separator of claim 1, wherein the overflow trough is comprised of peripheral enclosing plate, an inclined bottom plate, an inner enclosing plate, a lower cone-plate, a flange for overflow trough and a tailing ore pipe, wherein the peripheral enclosing plate and the inner enclosing plate are connected by the inclined bottom plate to constitute a tailing ore chute, and wherein the inclined bottom plate is an inclined structure that is high at one end and low at the other end.

9. The intelligent elutriation magnetic separator of claim 8, wherein the inner enclosing plate and the flange for overflow trough are connected through the lower cone-plate, which plays a role of transition, and wherein the diameter of the inner enclosing plate is larger than that of the separation tank.

10. The intelligent elutriation magnetic separator of claim 1, wherein spacing between the excitation coils and the outer cover is 1-500 mm.

11. The intelligent elutriation magnetic separator of claim 1, wherein the lower portion of the separation tank is connected with the water supply system of a circular shape, wherein the internal chamber of which is connected with the main water supply pipe in the tangential direction, and wherein there is one or more main water supply pipes.

12. The intelligent elutriation magnetic separator of claim 2, wherein the auxiliary water supplement system comprises an auxiliary water supply pipe, a flow guide pipe and tangential spiral divisional pipes, and wherein there are one or more auxiliary water supply pipes.

13. The intelligent elutriation magnetic separator of claim 12, wherein a direction of the water outlet of the tangential spiral divisional pipes is peripheral tangential direction, and wherein the tangential spiral divisional pipes are two or more.

14. The intelligent elutriation magnetic separator of claim 1, wherein the sensor is a concentration sensor or a pressure sensor for measuring the slurry concentration of the separation tank.

15. The intelligent elutriation magnetic separator of claim 1, wherein the concentrate discharging system is a pipe clamp valve and an electric controller.

16. A method for magnetic separation, comprising the following steps:
assembling an intelligent elutriation magnet separator, according to claim 1;
feeding slurry through the material feeding trough, flows downward along the material feeding pipe and enters uniformly into the separation tank from a cage-type exit on the lower portion of the material feeding pipe;
after the slurry is fed into the separation tank, forming a magnetic chain in a vertical direction of the magnetic particles that are connected by the action of downward movement magnetic force generated by a plurality of groups of excitation coils and gravitational force and suspends downwards, wherein the materials are blocked by the balance column and are dispersed at the space between the balance column and the separation tank, and wherein the magnetic field intensity and the pulse cycle of all the coils in the excitation coils are adjustable;
distributing non-magnetic gangue particles in the periphery of the magnetic chain, the risen rinse water being fed into the separation tank in the tangential direction from the water supply system on the lower portion of the separation tank and moves upwards in a spiral mode inside the separation tank, and the gangue particles float with the ascending water to the overflow trough overflows and to be discharged to form tailing;
feeding the supplement water from the auxiliary water supply system located in the lower cone and is flushed into the separation tank from the tangential spiral divisional pipes through the flow guide pipe; and
moving the magnetic particles downwards to the concentrate discharging system in a magnetic chain state, and to be discharged.
